(19) United States
(12) Patent Application Publication
(10) Pub. No.: US 2026/0240113 A1
(43) Pub. Date: Aug. 20, 2026

(54) HAIR AND FUR DRYING BRUSH

(71) Applicant: Charles Urso, Sea Ranch Lakes, FL (US)

(72) Inventor: Charles Urso, Sea Ranch Lakes, FL (US)

(21) Appl. No.: 19/055,047

(22) Filed: Feb. 17, 2025

(51) Int. Cl. A01K 13/00; A46B 9/02; A46B 15/00

(52) U.S. Cl. CPC A01K 13/002; A01K 13/001; A46B 9/023; A46B 15/0051; A46B 2200/104

(57) ABSTRACT

A grooming device includes a handle and brush head having a top side and a bottom side all surrounding a hallow interior cavity. The bottom side includes a bottom plate that is movable in relation to bristles that extend through an arrangement of slotted openings in the movable plate for removing hair and fur from the bristles. The bottom side further includes an air discharge opening in airflow communication with the hollow interior of the brush head and handle. A flexible hose connects to the handle and an electrically powered airflow generating device (e.g., a blow dryer) for directing airflow through the hallow interior cavity, out through the air discharge opening and onto hair or fur when brushing.

### BACKGROUND OF THE INVENTION

### Field of the Invention

The present invention relates to grooming devices and, more particularly, a grooming device for simultaneously drying and brushing hair and fur.

### Description of the Related Art

After shampooing, it is necessary to dry and brush hair or fur. This is particularly the case for pets, such as dogs or cats, as well as humans with longer hair. Some pet owners use grooming services for their pets which typically includes bathing, brushing and trimming the animals coat. Regular grooming is an important aspect of an animal's general health and wellbeing and, furthermore, it is beneficial for controlling shedding of the pet's coat. After bathing, hair or fur must be dried and brushed to prevent matting of the animal's coat. Unfortunately, it often takes a significant amount of time to both dry and subsequently brush the animal's hair or fur. While various devices have been proposed for simultaneously drying and brushing an animal's coat in a time efficient manner, these various devices have generally been ineffective, bulky and in many cases very costly, thereby rendering them inefficient and/or impractical for manufacture or use.

Accordingly, there remains a need for an affordable grooming device that can be easily manufactured and which simultaneously dries and brushes the hair and fur in less time. Moreover, there is a need for an affordable and highly efficient grooming device for brushing and drying hair and fur, and wherein the grooming device is designed to be used in combination with a conventional electric hair dryer.

### SUMMARY OF THE INVENTION

The present invention is directed to a grooming device and, more particularly, a brush that connects to a conventional hairdryer (i.e., blow dryer) for drying hair or fur while simultaneously brushing the hair or fur. In one embodiment, the brush of the present invention is particularly suited for use as a pet grooming device. The hair and fur drying brush includes a handle portion and a brush head having a top side and a bottom side. The brush head includes an arrangement of bristles extending downwardly from the bottom side. In at least one embodiment, the bristles extend down through an arrangement of slotted openings formed in a movable plate that is movable relative to the bottom side of the brush head and the bristles from a relaxed position to a downward, extended position by applying a downwardly depressing force on a knob or button on the top side of the brush head. Downward movement of the plate relative to the bristles allows for removal of hair and fur from the bristles.

The handle portion includes an open end for connection to a flexible air hose. An opposite end of the air hose connects to the nozzle of the hair dryer. The open end of the handle is in airflow communication with an air discharge opening on the bottom side of the brush head. With the flexible hair hose connected to both the handle portion and the air dryer, operation of the hair dryer delivers a forced flow of warm air through the flexible hose, the open end of the handle and out from the air discharge opening on the bottom side of the brush head. Accordingly, when brushing hair or fur with the brush while connected to the hair dryer, warm air can be directed onto the hair or fur during the brushing process, thereby allowing for faster and more efficient drying of the hair or fur.

### BRIEF DESCRIPTION OF THE DRAWINGS

For a fuller understanding of the nature of the present invention, reference should be had to the following detailed description taken in connection with the accompanying drawings in which:

FIG. 1 is a top, rear perspective view of the hair and fur drying brush of the present invention;

FIG. 2 is a bottom, front perspective view of the hair and fur drying brush of FIG. 1;

FIG. 3 is an end elevational view of the hair and fur drying brush showing an open end of the handle of the brush;

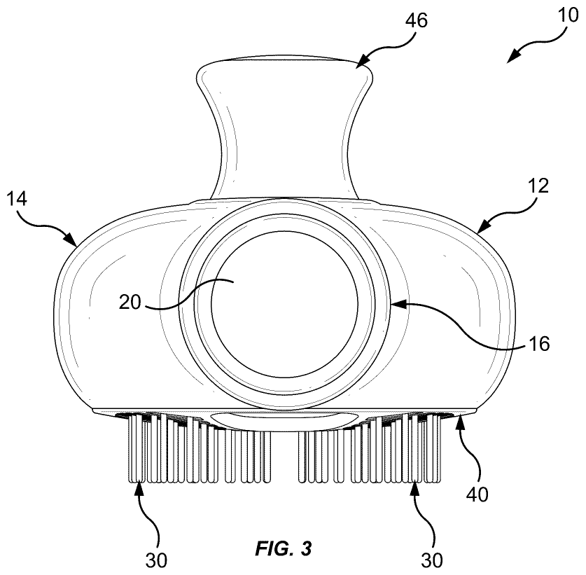

FIG. 4A is a side elevational view of the hair and fur drying brush of FIG. 1 and showing a movable hair and fur removal plate in a retracted, relaxed position with the bristles of the brush extending outwardly and beyond slotted openings in the plate;

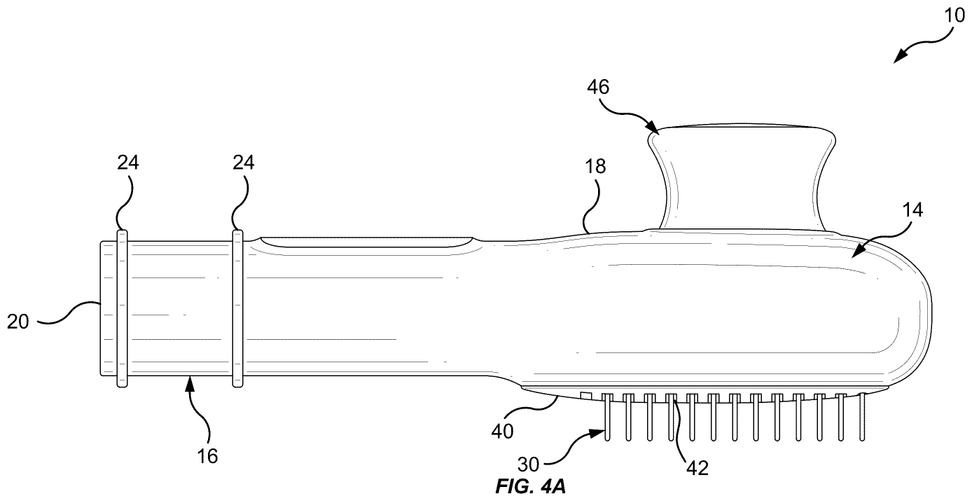

FIG. 4B is a side elevational view similar to the side elevational view in FIG. 4A, and showing the hair and fur removal plate moved to an extended position against an internal spring force upon depressing a knob on the top of the brush, to thereby allow for removal of hair and fur from the brush bristles;

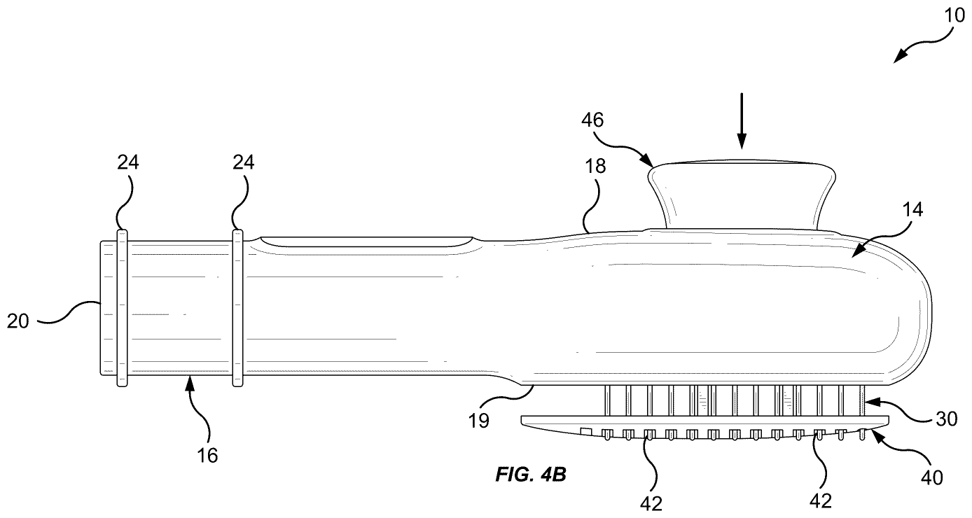

FIG. 5 is a bottom plan view of the hair and fur drying brush of FIG. 1 and showing the slotted openings in the plate as well as an air discharge opening;

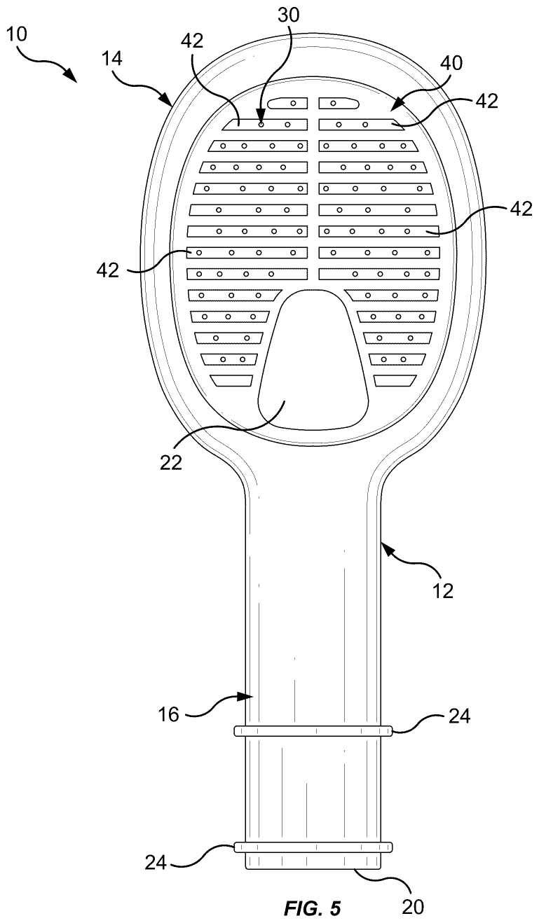

FIG. 6A is a top perspective view showing a flexible hose in relation to an electrically powered hair dryer and the hair and fur drying brush of the present invention, and separated therefrom; and

FIG. 6B is a top perspective view2 showing the flexible hose securely attached to both the electric hair dryer and the open end of the handle of the hair and fur drying brush, whereby a forced flow of warm air from the electric hair dryer is delivered to a hollow interior cavity of the brush for release out of the discharge opening on the bottom side and onto the hair and fur when using the brush on an animal or human.

Like reference numerals refer to like parts throughout the several views of the drawings.

### DETAILED DESCRIPTION OF THE PREFERRED EMBODIMENTS

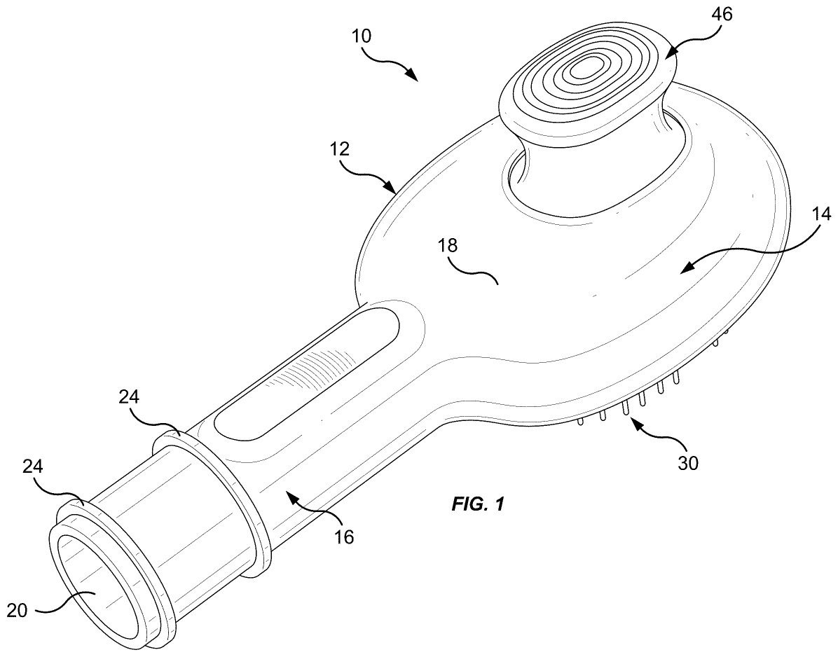

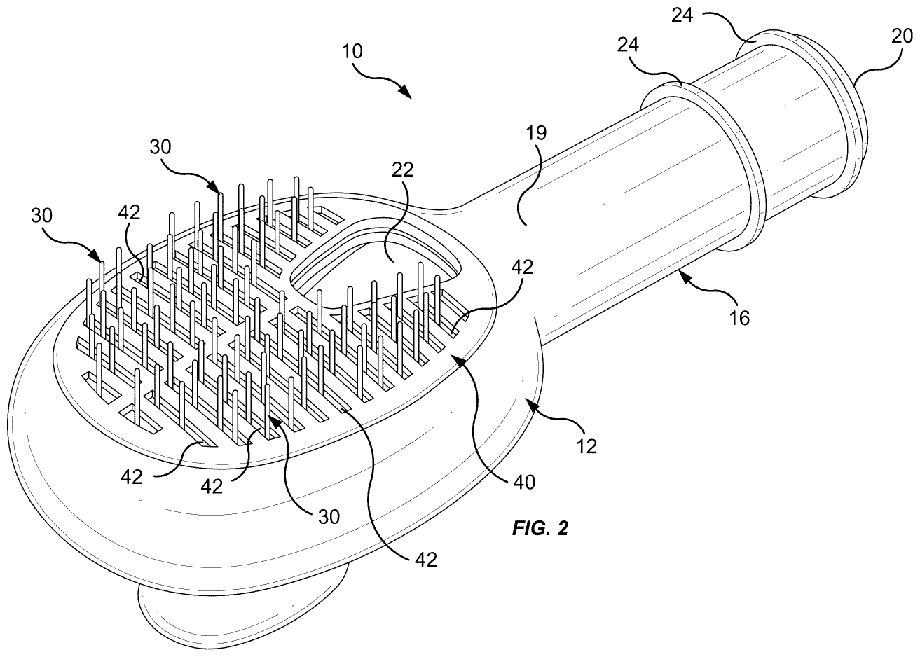

Referring to the several views of the drawings, and initially FIGS. 1-2, the hair and fur drying brush of the present invention is shown and is generally indicated as 10 throughout the several drawing figures. The brush 10 includes a main body 12 that surrounds a hollow interior throughout a handle portion 16 and a head portion 14. The main body 12 further includes a top side 18 and a bottom side 19. The handle portion 16 includes an open end 20 in airflow communication with the hollow interior of the main body 12 of the brush 10 and further in airflow communication with an air discharge opening 22 on a bottom side of the brush head. The bottom side of the head portion 14 includes a movable plate 30 having an arrangement of elongated slots 42, as seen in FIG. 2. An arrangement of brush bristles 30 extends out through the multiple rows of elongated slots 42, again as seen in FIG. 2. The handle portion 16 further includes a pair of spaced annular rings 24 that provide for attachment of a flexible air hose 50, as described hereinafter.

The bottom plate 40 is movable downwardly and away from the bottom side 19 of the main body 12 against a spring force. More specifically, application of a downward force on spring loaded button 46 on the top side 18 of the main body, and particularly on the head portion 14, urges the plate downwardly relative to the bottom side 19 of the main body, and particularly the brush head 14. Downward movement of the plate 40 allows for removal of hair or fur that gets tangled within the arrangement of brush bristles 30.

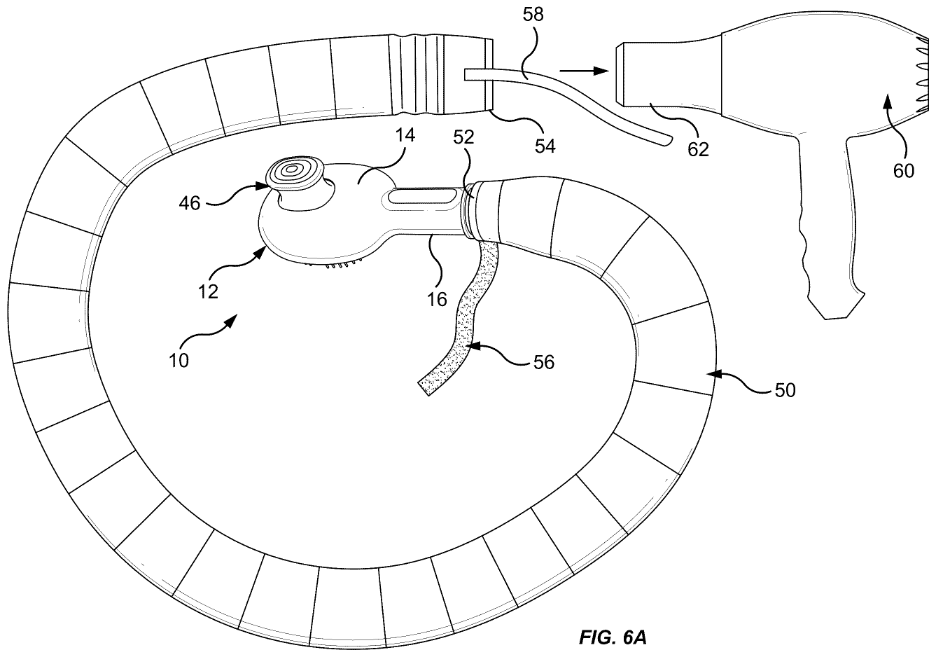

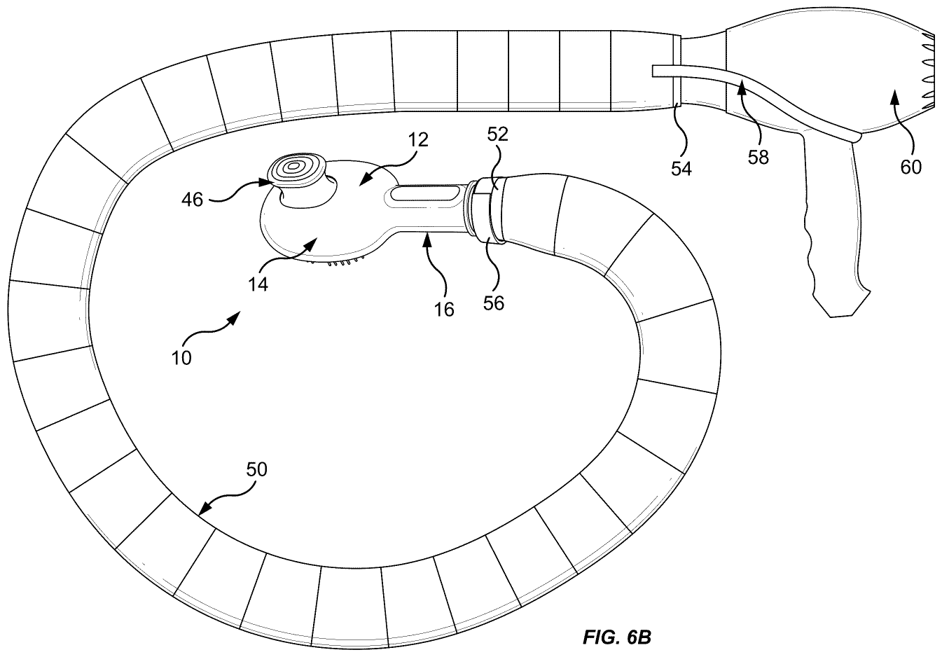

Referring to FIGS. 6A and 6B, the hair and fur drying brush 10 of the present invention is specifically designed for attachment to an electrically powered warm airflow generating device. More specifically, the hair and fur drying brush 10 attaches to the nozzle end 62 of an electric hair dryer 60, so that warm air discharged from the nozzle end 62 of the hair dryer is forced through the flexible hose 50 when the end 54 of the hose is fitted over the nozzle end 62 of the hair dryer 60. An elastomeric looped strap 58 is used to hold the end 54 of the flexible hose 50 over the nozzle end 62 of the hair dryer, as seen in FIG. 6B. More specifically, the elastomeric looped strap 58 is fitted behind the handle of the hair dryer, thereby preventing accidental or inadvertent separation of the air hose 50 from the nozzle end 62 hair dryer 60. The opposite end 52 of the flexible hose 50 is secured to the handle portion 16 of the brush 10. To provide for a more secure attachment, the end 52 of the hose is fitted over at least one of the annular rings 24 on the handle portion 16 and a securing strap 56 may be used to further hold the end 52 of the flexible hose on the handle 16 of the brush 10. In this particular example, the securing strap 56 may include hook and loop fasteners that allow the strap 56 to be wrapped around the end 52 while applying enough pressure to hold the end 52 of the flexible hose 50 on the handle portion 16. In other embodiments of the invention, the strap 56 may not be necessary. When the flexible hose 50 is secured to both the hair and fur drying brush 10 and the hair dryer 60, operation of the hair dryer serves to direct a forced flow of warm air through the flexible hose 50 to the hollow interior of the main body 12 of the hair and fur drying brush 10, through the open end 20 in the handle portion and outwardly from the air discharge opening 22 on the bottom side 19 of the brush 10. Thus, when brushing hair or fur with the hair and fur drying brush, the discharge of warm air from the air discharge opening 22 serves to simultaneously dry the hair or fur. The use of the elongated flexible hose 50 allows the hair dryer 60 to be positioned away from an animal, such as a dog or cat, so that the animal is not frightened by the operation of the electric hair dryer 60 or other electrically powered warm air flow generating device.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A grooming device for use in combination with an electronically powered airflow generating device, said grooming device comprising:
a brush member having a main body and including a handle portion with an open end and a brush head integral with the handle portion and including a top side and a bottom side, and the bottom side including at least one air discharge opening in airflow communication with the open end of the handle, and a spaced arrangement of bristles extending downwardly from the bottom side of the brush head; and
a flexible hose having a first end structured for attachment to the handle portion of the brush in surrounding and covering relation to the open end in the handle portion, and an opposite second end structured for attachment to the electrically powered airflow generating device to direct airflow generated by the airflow generating device through the flexible hose and through the open end of the handle portion and outwardly from the at least one air discharge opening on the bottom side of the brush head.

2. The grooming device as recited in claim 1 further comprising:
a movable plate member on the bottom side of the brush head and including an arrangement of elongate slotted openings for passage of the arrangement of bristles therethrough, and the movable plate being movable downwardly relative to the bottom side of the brush head and the arrangement of bristles against a spring biasing force for removing hair and fur from the arrangement of bristles.

3. The grooming device as recited in claim 2 further comprising:
a knob member on the top side of the brush head and in cooperating engagement with the movable plate, and the knob being structured to be operated from a relaxed position to a downwardly depressed position upon application of an external force to thereby move the movable plate member downwardly against the spring biasing force.

4. The grooming device as recited in claim 1 wherein the second end of the flexible hose includes an elastomeric strap for securing the second end of the flexible hose to the electrically powered airflow generating device.

5. The grooming device as recited in claim 4 wherein the first end of the flexible hose includes a strap member for securing the first end of the hose to the handle member of the brush.
